(19) United States
(12) Patent Application Publication
(10) Pub. No.: US 2025/0118107 A1
(43) Pub. Date: Apr. 10, 2025

(54) METHOD, DEVICE, AND NON-TRANSITORY COMPUTER READABLE MEDIUM FOR CAPTURING AND UTILIZING ANATOMICAL RANGE OF MOTION (ROM) AND POSTURAL ASSESSMENTS

(71) Applicant: Kinesics, LLC, Baton Rouge, LA (US)

(72) Inventors: Gerald J. DREFAHL, Baton Rouge, LA (US); Matthew T. ADLER, Baton Rouge, LA (US)

(73) Assignee: Kinesics, LLC, Baton Rouge, LA (US)

(21) Appl. No.: 18/910,165

(22) Filed: Oct. 9, 2024

Related U.S. Application Data
(60) Provisional application No. 63/589,186, filed on Oct. 10, 2023.

(51) Int. Cl. G06V 40/20; G06F 3/0346; G06T 13/40

(52) U.S. Cl. CPC G06V 40/20; G06F 3/0346; G06T 13/40

(57) ABSTRACT

A mobile device may be configured to capture anatomical data for a subject and perform an assessment of a functional movement of the subject based on the anatomical data for the subject by, capturing the anatomical data for the subject via the mobile device such that the anatomical data includes range of motion (ROM) or postural measurements of one or more joints of the subject determined based on a rotation of the mobile device along a z-axis collected by one or more of an accelerometer and a gyroscope embedded within the mobile device, instructing a server to analyze the functional movement of the subject based on the anatomical data and to generate assessment data based on same, and displaying, via a user interface of the mobile device, the anatomical data and the assessment of the functional movement of the subject based on the assessment data received from the server.

### CROSS REFERENCE TO RELATED APPLICATIONS

The present U.S. Utility patent application claims priority pursuant to 35 U.S.C. § 119 (e) to U.S. Provisional Application No. 63/589,186, filed Oct. 10, 2023, which is incorporated herein by reference in its entirety.

### BACKGROUND

### Field

Various example embodiments are related to methods, devices, and/or non-transitory computer readable mediums configured to capture and utilize anatomical range of motion (ROM) and postural assessments.

### Description of the Related Art

The statements in this section merely provide background information related to example embodiments and may not constitute prior art.

Conventionally, it may be difficult to accurately capture anatomical data indicating a range of motion (ROM) of one or more body parts of a subject, and, thus, it may be difficult to assess and analyze the ROM of a subject in an effort to assess and objectively quantify the ROM to, for example, diagnose issues with the subject's joints, and potentially refer the subject for further evaluation and apply corrective interventions to change and ultimately improve or eliminate these issues to increase the ROM of the subject.

Conventional equipment used to capture such anatomical data may be analog in nature or may require dedicated equipment that simply outputs a raw ROM of one or more body parts of the subject without allowing an operator, such as a medical professional, allied healthcare professional, and/or human performance professional, to easily capture multiple data points associated with assessing the ROM, and may not assist the operator with performing the assessment, analyzing postural and ROM measurements, qualifying the subject for further evaluations, and/or assigning interventions based on the assessment. Further, such conventional equipment may not allow the operator to generate a collective program of interventions that are easily reusable and re-assignable to different subjects based on a related outcome of their individual assessments.

### SUMMARY

At least some example embodiment provide a mobile device including processing circuitry and a memory, the memory containing computer readable code that, when executed by the processing circuitry, configures the mobile device to capture anatomical data for a subject and perform an assessment of a functional movement of the subject based on the anatomical data for the subject by, capturing the anatomical data for the subject via the mobile device such that the anatomical data includes range of motion (ROM) or postural measurements of one or more joints of the subject determined based on a rotation of the mobile device along a z-axis collected by one or more of an accelerometer and a gyroscope embedded within the mobile device, instructing a server to analyze the functional movement of the subject based on the anatomical data and to generate assessment data based on same, and displaying, via a user interface of the mobile device, the anatomical data and the assessment of the functional movement of the subject based on the assessment data received from the server.

In some example embodiments, the mobile device is further configured to perform an initialization operation to set an initial rotational angle based on an angle the mobile device is positioned on the subject when an initialization command is received from an operator, and to determine the rotation of the mobile device along the z-axis based on the initial rotational angle.

In some example embodiments, the mobile device is further configured to determine whether the mobile device is positioned horizontally or vertically based on a difference between an acceleration vector which includes components sensed by the accelerometer and an output of the z-axis which is a component sensed by the gyroscope.

In some example embodiments, the mobile device is configured to capture the anatomical data for the subject by, calculating a degrees of rotation of the mobile device in a vertical plane based on accelerometer data associated with the accelerometer embedded within the mobile device, in response to the anatomical data being captured while the mobile device is determined as being positioned vertically; and calculating the degrees of rotation in a horizontal plane based on gyroscope data associated with the gyroscope embedded within the mobile device, in response to the anatomical data being captured while the mobile device is determined as being positioned horizontally.

In some example embodiments, the mobile device is configured to display the assessment of the functional movement by displaying one or more of functional movement scores, a joint mobility score, severity categories, an overall mobility score, and an avatar of the subject.

In some example embodiments, the mobile device is further configured to collect metadata associated with the anatomical data and transmit the metadata to the server, the metadata including at least time data, subject data, and operator data, and wherein the server is configured to analyze the functional movement based on the anatomical data and the metadata by, obtaining demographic-specific insights applicable to the subject based on the subject data, analyzing the functional movement of the subject across different time periods, which are identified based on the time data, and linking the anatomical data to a specific operator of the mobile device based on the operator data such that the server is configured to generate quality control data indicating an accuracy of the assessment conducted by different operators.

In some example embodiments, the mobile device is further configured to instruct an operator thereof to capture the anatomical data associated with different ones of the ROM or postural measurements.

In some example embodiments, the mobile device is configured to instruct the operator thereof to capture the anatomical data associated with each of the ROM or postural measurements in a set order, the set order being customizable and reusable by the operator when evaluating different ones of a plurality of subjects.

In some example embodiments, the mobile device is configured to allow the operator to skip or redo the capturing of the anatomical data associated with one or more the ROM or postural measurements in response to input from the operator.

Some example embodiments are directed to a method of operating a mobile device to capture anatomical data for a subject and perform an assessment of a functional movement of the subject based on the anatomical data for the subject. In some example embodiments, the method includes capturing the anatomical data for the subject via the mobile device such that the anatomical data includes range of motion (ROM) or postural measurements of one or more joints of the subject determined based on a rotation of the mobile device along a z-axis collected by one or more of an accelerometer and a gyroscope embedded within the mobile device; instructing a server to analyze the functional movement of the subject based on the anatomical data and to generate assessment data based on same; and displaying, via a user interface of the mobile device, the anatomical data and the assessment of the functional movement of the subject based on the assessment data received from the server.

Some example embodiments are directed to a non-transitory computer readable medium storing computer code that, when executed by a mobile device, configures the mobile device to perform the method of capturing anatomical data for a subject and performing an assessment of a functional movement of the subject based on the anatomical data for the subject.

Some example embodiments are directed to a server including processing circuitry and a memory, the memory containing computer readable code that, when executed by the processing circuitry, configures the server to analyze functional movement of a subject based on anatomical data for the subject.

In some example embodiments, the server is configured to analyze the functional movement of the subject based on the anatomical data for the subject by receiving the anatomical data for the subject captured by a mobile device, the anatomical data including range of motion (ROM) or postural measurements of one or more joints of the subject determined based on a rotation of the mobile device along a z-axis collected by one or more of an accelerometer and a gyroscope embedded within the mobile device, storing the anatomical data in a database within a memory device, analyzing the functional movement of the one or more joints of the subject based on the ROM or postural measurements and database information, and transmitting results of the analyzing of the functional movement of the one or more joints of the subject to the mobile device.

In some example embodiments, the server is configured to receive metadata associated with the anatomical data for the subject from the mobile device such that the metadata includes at least time data, subject data, and operator data, and analyze the functional movement based on the anatomical data and the metadata by, obtaining demographic-specific insights applicable to the subject based on the subject data, analyzing the functional movement of the subject across different time periods, which are identified based on the time data, and linking the anatomical data to a specific operator of the mobile device based on the operator data such that the server is configured to generate quality control data indicating an accuracy of the assessment conducted by different operators.

In some example embodiments, the server is configured to analyze the functional movement by, determining, from the database information stored in the database, ideal values for respective ones the ROM or postural measurements and a plurality of measurement ranges associated with each of the ROM or postural measurements; scoring the ROM or postural measurements based on respective ones of the ideal values to generate functional movement scores; classifying the functional movement scores into respective ones of a plurality of severity categories based on which of the plurality of measurement ranges that the ROM or postural measurements falls within; and assigning a joint mobility score to the one or more joints based on the functional movement scores assigned to the anatomical data associated with a respective one of the one or more joints.

In some example embodiments, the server is further configured to analyze the functional movement by, assigning an overall mobility score to the subject based on the functional movement scores assigned to all of the one or more anatomical data associated with an assessment of the subject.

In some example embodiments, the server is further configured to analyze the functional movement by, generating an avatar of the subject such that the avatar indicates the severity categories assigned to corresponding ones of the ROM or postural measurements of the subject.

In some example embodiments, the server is configured to generate the avatar by color coding a graphical representation of a human anatomy based on the ROM or postural measurements of the subject.

In some example embodiments, the server is configured to transmit the results of the analyzing of the functional movement to the mobile device by, transmitting one or more of the functional movement scores, the joint mobility score, the severity categories, the overall mobility score and the avatar to the mobile device for display to an operator.

In some example embodiments, the server is configured to transmit the results of the analyzing of the functional movement in real-time as feedback to the operator as the anatomical data captured by the mobile device is received.

Some example embodiments are directed to a method of operating a server to analyze functional movement of a subject based on anatomical data for the subject.

In some example embodiments, the method of operating the server to analyze the functional movement of the subject based on the anatomical data for the subject may include receiving the anatomical data for the subject captured by a mobile device, the anatomical data including range of motion (ROM) or postural measurements for one or more joints of the subject determined based on a rotation of the mobile device along a z-axis collected by one or more of an accelerometer and a gyroscope embedded within the mobile device; storing the anatomical data in a database within a memory device; analyzing the functional movement of the one or more joints of the subject based on the ROM or postural measurements and database information; and transmitting results of the analyzing of the functional movement of the one or more joints of the subject to the mobile device.

In some example embodiments, the analyzing the functional movement includes determining, from the database information stored in the database, ideal values for respective ones the ROM or postural measurements and a plurality of measurement ranges associated with each of the ROM or postural measurements; scoring the ROM or postural measurements based on respective ones of the ideal values to generate functional movement scores; classifying the functional movement scores into respective ones of a plurality of severity categories based on which of the plurality of measurement ranges that the ROM or postural measurements falls within; and assigning a joint mobility score to the one or more joints based on the functional movement scores assigned to the anatomical data associated with a respective one of the one or more joints.

In at least some example embodiments, the method includes assigning one or more interventions to the subject from among a plurality of interventions stored in the memory based on instructions received from an operator; and transmitting information associated with the assigned interventions to the subject on demand, in response to a request for the information from the subject.

In at least some example embodiments, the assigning one or more interventions includes displaying the plurality of interventions to the operator via a user interface; and receiving the instructions indicating the assigned interventions via the user interface such that the instructions include at least an assigned repetition for each of the assigned interventions.

In at least some example embodiments, the method further includes storing the assigned interventions as a collective program of interventions associated with a particular movement disorder such that the collective program of interventions is reusable by the operator when assigning the one or more interventions to different ones of a plurality of subjects.

In at least some example embodiments, the transmitting information associated with the assigned interventions includes selectively transmitting the information associated with the collective program on demand by ones of the plurality of subjects with an active subscription to the collective program.

Some example embodiments are directed to a non-transitory computer readable medium storing computer code that, when executed by a server, configures the server to perform the method of analyzing functional movement of a subject based on anatomical data for the subject.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The accompanying drawings, which are incorporated in and constitute a part of the specification, illustrate one or more example embodiments and, together with the description, explain these example embodiments. In the drawings:

FIG. 1 illustrates a server according to example embodiments;

FIG. 2 illustrates a mobile device according to example embodiments;

FIGS. 3A, 3B, 4A and 4B illustrates a mobile device capturing anatomical data according to example embodiments;

FIG. 5 illustrates a mobile device performing an initialization operation according to example embodiments;

FIG. 6 illustrates a method of operating a mobile device to capture anatomical data and provide analysis of the same according to example embodiments;

FIG. 7 illustrates a method of operating a mobile device to capture anatomical data of a subject according to example embodiments;

FIG. 8 illustrates a method of operating a server to analyze functional movement based on captured anatomical data according to example embodiments;

FIG. 9 illustrates a method of analyzing functional movement of one or more joints according to example embodiments;

FIG. 10 illustrates data flow diagrams associated with determining the anatomical data and analyzing the functional motion according to example embodiments; and

FIG. 11 illustrates a user interface according to example embodiments.

### DETAILED DESCRIPTION

Various example embodiments will now be described more fully with reference to the accompanying drawings in which some example embodiments are shown.

Detailed example embodiments are disclosed herein. However, specific structural and functional details disclosed herein are merely representative for purposes of describing the example embodiments. The example embodiments may be embodied in many alternate forms and should not be construed as limited to only the example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the example embodiments. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular example embodiments only and is not intended to be limiting of the example embodiments. As used herein, the singular forms “a,” “an,” and “the,” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Specific details are provided in the following description to provide a thorough understanding of the example embodiments. However, it will be understood by one of ordinary skill in the art that example embodiments may be practiced without these specific details. For example, systems may be shown in block diagrams in order not to obscure the example embodiments in unnecessary detail. In other instances, well-known processes, structures, and techniques may be shown without unnecessary detail in order to avoid obscuring example embodiments.

Also, it is noted that example embodiments may be described as a process depicted as a flowchart, a flow diagram, a data flow diagram, a structure diagram, or a block diagram. Although a flowchart may describe the operations as a sequential process, many of the operations may be performed in parallel, concurrently, or simultaneously. In addition, the order of the operations may be re-arranged. A process may be terminated when its operations are completed, but may also have additional steps not included in the figure. A process may correspond to a method, a function, a procedure, a subroutine, a subprogram, etc. When a process corresponds to a function, its termination may correspond to a return of the function to the calling function or the main function.

Moreover, as disclosed herein, the term “memory” may represent one or more devices for storing data, including random access memory (RAM), magnetic RAM, core memory, and/or other machine-readable mediums for storing information. The term “storage medium” may represent one or more devices for storing data, including read only memory (ROM), random access memory (RAM), magnetic RAM, core memory, magnetic disk storage mediums, optical storage mediums, flash memory devices and/or other machine-readable mediums for storing information. The term “computer-readable medium” may include, but is not limited to, portable or fixed storage devices, optical storage devices, wireless channels, and various other mediums capable of storing, containing, or carrying instruction(s) and/or data.

Furthermore, example embodiments may be implemented by hardware circuitry and/or software, firmware, middleware, microcode, hardware description languages, etc., in combination with hardware (e.g., software executed by hardware, etc.). When implemented in software, firmware, middleware or microcode, the program code or code segments to perform the desired tasks may be stored in a machine or computer readable medium such as a non-transitory computer storage medium, and loaded onto one or more processors to perform the desired tasks.

A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

As used in this application, the term “circuitry” and/or “hardware circuitry” may refer to one or more or all of the following: (a) hardware-only circuit implementation (such as implementations in only analog and/or digital circuitry); (b) combinations of hardware circuits and software, such as (as applicable): (i) a combination of analog and/or digital hardware circuit(s) with software/firmware, and (ii) any portions of hardware processor(s) with software (including digital signal processor(s)), software, and memory(ies) that work together to cause an apparatus, such as a mobile phone, a smart device, and/or server, etc., to perform various functions); and (c) hardware circuit(s) and/or processor(s), such as microprocessor(s) or a portion of a microprocessor(s), that requires software (e.g., firmware) for operation, but the software may not be present when it is not needed for operation. For example, the circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the following terms discussed in the specification may be defined as follows, however, example embodiments are not limited thereto and may be defined differently herein:
Range of Motion (ROM) Measurement—May refer to a metric that represents a degree of movement of a specific joint in the body of the subject;
Postural Measurement—May refer to a metric that represents the alignment and positioning of the body of the subject in a specific of desired posture;
Anatomical Data—May refer to both range of motion measurements and postural measurements and may be expressed in degrees (e.g., from 0° to) 360°;
Metadata—May refer to any data collected in database that is not the anatomical data; Assessment—May refer to the act of capturing and saving anatomical data on a subject associated with a specific period of time;
Subject—May refer to the person receiving the assessment;
Operator—May prefer to the person performing the assessment by using the device to capture the anatomical data;
Functional Movement Score—May refer to a result of a calculation performed on one or more pieces of the anatomical data associated with a particular joint and may be expressed as a percentage (e.g. from 0% to 100%);
Joint Mobility Score—May refer to a result of a calculation performed on all of the anatomical data associated with a particular joint and may be expressed as a percentage (e.g. from 0% to 100%); and
Overall Mobility Score—May refer to a result of a calculation performed on all the anatomical data associated with a particular assessment and may be expressed as a percentage (e.g. from 0% to 100%).

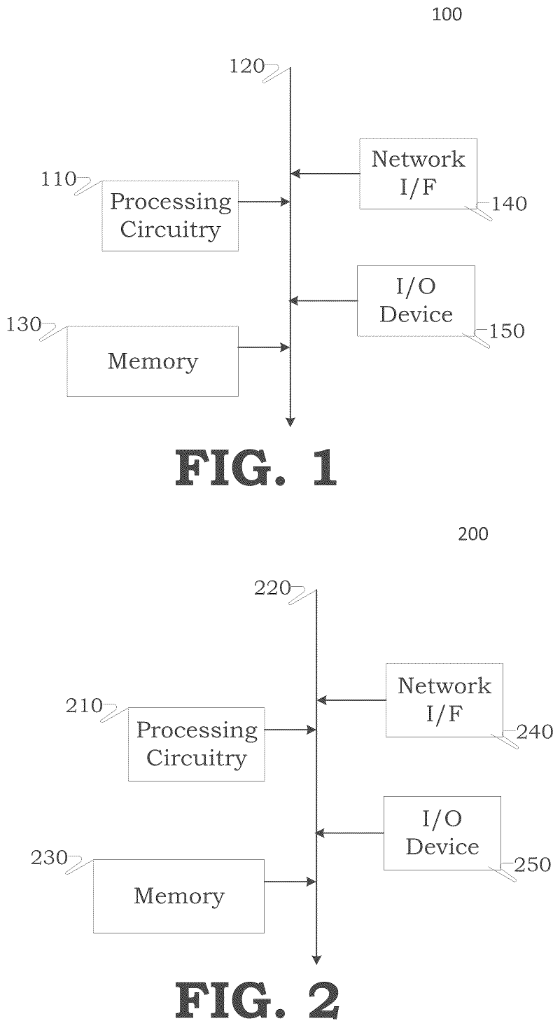

FIGS. 1 and 2 illustrate a server and a mobile device, respectively, configured to capture and utilize anatomical range of motion and postural assessments.

Referring to FIGS. 1 and 2, a server 100 may include processing circuitry 110 such as at least one processor, at least one communication bus 120, a memory 130, and at least one network interface (I/F) 140. Further, the server 100 may also include at least one input/output (I/O) device 150 (e.g., a keyboard, a monitor, a touchscreen, a mouse, a microphone, a camera, a speaker, etc.), etc., but the example embodiments are not limited thereto. The server 100 may be configured to communicate with at least one mobile device 200.

As discussed in more detail below with reference to FIG. 10, the processing circuitry 110 may be configured to include an Application Program Interface (API) 110-1 and a database server 110-2, such as an SQL server. However, example embodiments are not limited thereto. The database server 110-2 may store and retrieve data as requested by other software applications-which may run either on the server 100 or on another computer across a network (e.g., including the Internet).

Further, as discussed below with reference to FIG. 10, the memory 130 may include a relational database 130-1. However, example embodiments are not limited thereto. The relational database 130-1 may be a collection of highly structured tables, wherein each row of the tables reflects a data entity, and each column defines a specific information field. The relational database 130-1 may be built using the structured query language (SQL) to create, store, update, and retrieve data such that the relationship database is a SQL database.

Each mobile device 200 may include processing circuitry 210 such as at least one processor, at least one communication bus 220, a memory 230, and at least one network interface (I/F) 240, but the example embodiments are not limited thereto. Further, the mobile device 200 may also include an I/O device 250 (e.g., a keyboard, a monitor, a touchscreen, a mouse, a microphone, a camera, a speaker, etc.), The processing circuitry 210 may utilize the I/O device 250 to provide an interactive user interface in which an operator may view data and enter commands.

The memories 130, 230 may store various special purpose program code including computer executable instructions which may cause a respective one of the server 100 and the mobile device 200 to perform their respective operations associated with one or more of the methods of the example embodiments, including but not limited to a method of capturing and utilizing anatomical range of motion and postural assessments.

In at least one example embodiment, each processing circuitry 110, 210 may include processor cores, distributed processors, or networked processors. Each processing circuitry 110, 210 may be configured to control one or more elements of a respective one of the server 100 and the mobile device 200. The processing circuitries 110, 210 are configured to execute processes by retrieving program code (e.g., computer readable instructions) and data from a respective one of the memories 130, 230 to process them, thereby executing special purpose control and functions. Once the special purpose program instructions are loaded into, (e.g., the at least one processor), the respective processing circuitry 110, 210 executes the special purpose program instructions, thereby transforming the respective processing circuitry 110, 210 into a special purpose processor.

In at least one example embodiment, the memories 130, 230 may be non-transitory computer-readable storage mediums and may include a random-access memory (RAM), a read only memory (ROM), and/or a permanent mass storage device such as a disk drive, or a solid-state drive. Stored in the memories 130, 230 are program code (i.e., computer readable instructions) as described herein for controlling respective ones of the processing circuitries 110, 210, the network I/Fs 140, 240, and/or I/O devices 150, 250 etc.

Such software elements may be loaded from a non-transitory computer-readable storage medium independent of the memories 130, 230 using a drive mechanism (not shown), or via respective ones of the network I/Fs 140, 240 and/or respective ones of the I/O devices 150, 250, etc.

In at least one example embodiment, the communication buses 120, 220 may enable communication and/or data transmission to be performed between elements of respective ones of the server 100 and the mobile device 200. The communication buses 120, 220 may be implemented using a high-speed serial bus, a parallel bus, and/or any other appropriate communication technology. According to some example embodiments, the server 100 and mobile device 200 may include a plurality of communication buses (not shown).

While FIGS. 1 and 2 depict an example embodiment of the server 100 and the mobile device 200, the server 100 and mobile device 200 are not limited thereto, and may include additional and/or alternative architectures that may be suitable for the purposes demonstrated. For example, the functionality of the server 100 and the mobile device 200 may be divided among a plurality of physical, logical, and/or virtual servers and/or mobile devices, network elements, etc.

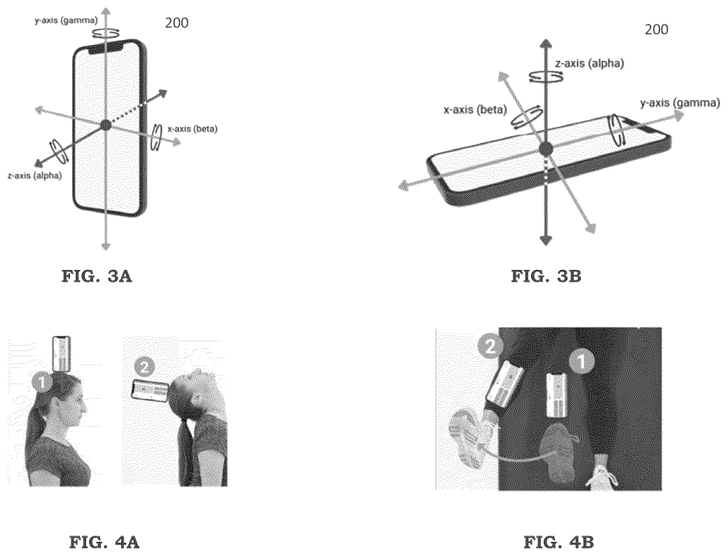

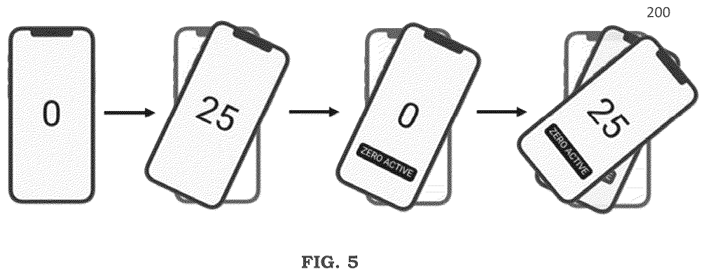

FIGS. 3A, 3B, 4A and 4B illustrates a mobile device capturing anatomical data according to example embodiments.

Referring to FIGS. 3A, 3B, 4A and 4B, the mobile device 200 may capture anatomical data of a subject as the mobile device 200 rotates, for example, along with rotation of a body part, such as a limb, of the subject. Labels 1 and 2 in FIGS. 4A and 4B may represent the physical locations of the mobile device 200 in space relative to the subject while the operator captures the anatomical data. Label 1 may be the physical location of the mobile device 200 when the mobile device 200 performs the initialization operation. Label 2 may be the physical location of the mobile device 200 when the capture operation is performed and the anatomical data is stored.

The anatomical data captured by the mobile device 200 may be based on a rotational measurement of the mobile device 200 collected by the mobile device 200.

The mobile device 200 may be a smart phone that includes a built-in gyroscope and accelerometer. The mobile device 200 may generate a “devicemotion” event that contains acceleration, rotation rate and interval time associated with one or more of the acceleration and rotation rate, and may generate a “deviceorientation’ event that contains information about the orientation or tilting of the mobile device 200 expressed as, for example, alpha (α), beta (β) and gamma (γ) rotational angles, which constitute a representation of an orientation of the mobile device 200 in a three-dimensional space. The information may have the format [α, β, γ].

The alpha (α) angle corresponds to the orientation of the mobile device 200 about its z-axis, and quantifies the rotation of the mobile device 200 in a plane parallel to the ground, with a range from 0° to 360°. The beta (β) angle corresponds to the elevation of the mobile device 200 in reference to its x-axis, and quantifies the anterior-posterior tilt of the mobile device 200, with a range spanning −180° to 180°, where positive values indicate tilting the top of the mobile device 200 forward. The gamma (γ) angle corresponds to the lateral tilt of the mobile device 200 about its y-axis, and quantifies the deviation from the vertical plane, with a range spanning −90° to 90°. Collectively, these angles provide a comprehensive description of the spatial orientation of the mobile device 200.

The mobile device 200 is configured to capture the anatomical data only while the mobile device 200 is considered to be in a vertical or a horizontal position, where the captured information may be the z-axis (alpha) rotation of the mobile device 200 among the x-axis, y-axis and z-axis rotation of the mobile device 200.

FIG. 5 illustrates a mobile device performing an initialization operation according to example embodiments.

Referring to FIG. 5, prior to capturing the anatomical data, the mobile device 200 may be configured to perform an initialization operation by “zeroing” all of the outputs of the devicemotion and deviceorientation events and storing the orientation and position of the mobile device 200 at the zero position to allow measurements to proceed up to 360 degrees from the set zero position. As discussed in further detail below, if the mobile device 200 is determined to be in the vertical position, this stored value is called the “initialAngle;” and if the mobile device 200 is determined to be in the horizontal position, this stored value is called the “initialAlpha.” As also discussed in further details below, the initialization operation may include the mobile device 200 resetting the totalRotation when the mobile device 200 is in the vertical position, and the mobile device 200 resetting the totalFlatRotiaon when the mobile device 200 is in the horizontal position.

In some example embodiments, the mobile device 200 is set to update the displayed angle on the user interface at a set refresh rate (e.g., every 150 milliseconds) to provide a smoother visual feedback that is less influenced by inadvertent movements of the mobile device 200 due to, for example, disturbances caused by the operator and/or the subject.

When the operator provides a “capture” command via the user interface of the mobile device 200, a final reading may be determined and stored, and the mobile device 200 may cease capturing the anatomical data. For example, the final reading may be a reading corresponding to a time the operator provided the capture command or may be a maximum reading from a time of the initialization operation to a time of receipt of the capture command.

The final reading may be stored in the mobile device 200 along with metadata including, for example, “DeviceInfo”, “AccelerometerData”, “GyroscopeData”, “SubjectData”, “OperatorData”, and/or “TimeData.” However, example embodiments are not limited thereto.

The DeviceInfo may include information on the mobile device 200 such as the type and version of the mobile device 200 and the version of the operating system running on the mobile device 200. For example, Deviceinfo may have the form [{“RomDataUid”: 242, “UserAgent”: “Mozilla/5.0 (iPhone; CPU iPhone OS 15_5 like Mac OS X) AppleWebKit/605.1.15 (KHTML, like Gecko) Version/15.5 Mobile/15E148 Safari/604.1”, “OsVersion”: “15.5”, “Platform”: “web”, “Model”: “iPhone”, “Manufacturer”: “Apple Computer, Inc.”]}. The TimeData may include information indicating the amount of time from a time when the operator performed the initialization operation to a time of receipt of the capture command. The AcceleromterData and GyroscopeData may include acceleration information and angular velocity information, respectively. The AcceleromterData may include raw output data of the X, Y, and Z values, where the X value measures acceleration in the left and right direction of the mobile device 200, the Y value measures acceleration in the forward and backward direction of the mobile device 200, and the Z value measures acceleration in the up and down direction of the mobile device 200, each expressed in meters per second squared (m/s²). The GyroscopeData may include raw output data along the alpha (α), beta (β) and gamma (γ) axes, where the alpha axis captures the rotation of the mobile device 200 around the Z-axis (yaw), the beta axis measures tilting of the mobile device 200 along the X-axis (pitch), and the gamma axis records tilting of the mobile device 200 along the Y-axis (roll), all expressed in degrees per second (°/s). The SubjectData may include the subject's personal information such as first name, last name, date of birth, and/or gender, allowing for proper identification and demographic analysis in relation to the anatomical data. The OperatorData may include the operator's personal information such as first name, last name, date of birth, and gender, allowing for proper identification and demographic analysis in relation to the anatomical data.

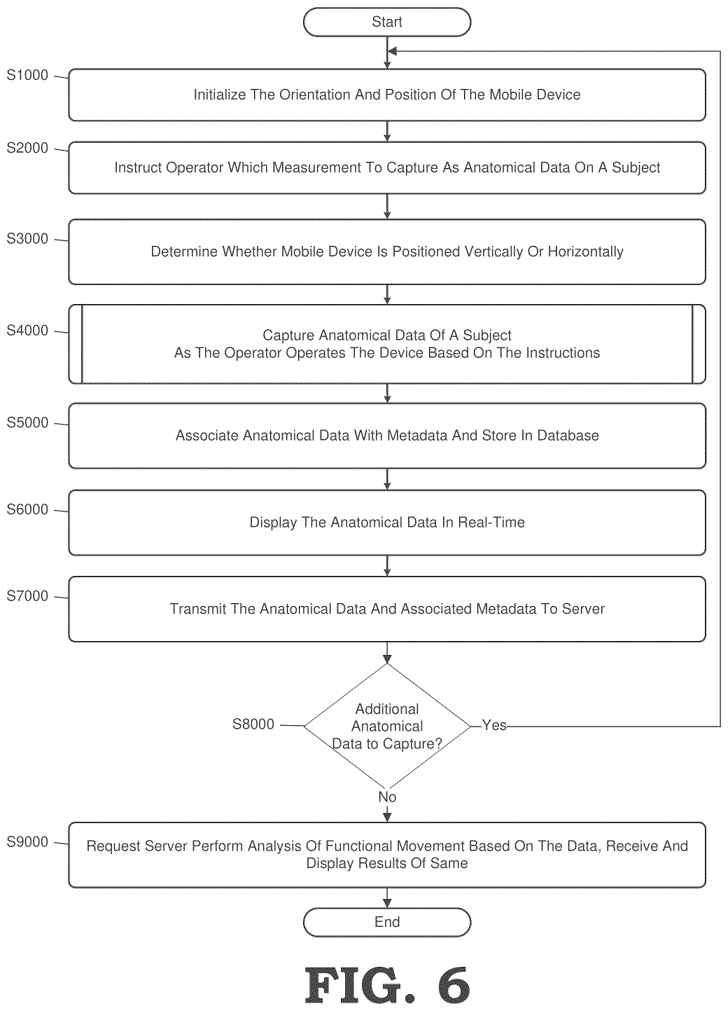

FIG. 6 illustrates a method of operating a mobile device to capture anatomical data and provide analysis of the same according to example embodiments.

Referring to FIG. 6, in operation S1000, the mobile device 200 may perform an initialization operation. In some example embodiments, the initialization operation may include “zeroing” all of the outputs of the devicemotion and deviceorientation events and storing the orientation and position of the mobile device 200 at the zero position to allow measurements to proceed up to 360 degrees from the set zero position. As discussed in further detail below, if the mobile device 200 is determined to be in the vertical position, this stored value is called the “initialAngle;” if the mobile device 200 is determined to be in the horizontal position, this stored value is called the “initialAlpha.” As also discussed in further details below, the initialization operation may include resetting the totalRotation when the mobile device 200 is in the vertical position and resetting the totalFlatRotiaon when the mobile device 200 is in the horizontal position.

In operation S2000, the mobile device 200 may instruct an operator thereof to capture the anatomical data for each of a plurality of ROM or postural measurements in a set order using a pre-determined list of measurements associated with the current assessment by indicating, to the operator, which measurement to capture at a particular point in the assessment.

In operation S3000, the mobile device 200 may determine whether the mobile device 200 is positioned in a vertical position or horizontal position based on a measured degree of position (p).

The mobile device 200 may determine the degree of position based on the difference between the acceleration vector V=sqrt(x²+y²+z²) sensed by the accelerometer sensor and the alpha value α, which is the Z-Axis component of rotation, sensed by gyroscope sensor using the following equation:

$$Degree of Position ( p ) = sqrt ( {x}^{2} + {y}^{2} + {z}^{2} ) - α \qquad ( Equation l )$$

The mobile device 200 may determine that the mobile device 200 is considered positioned in a vertical position or is considered in a horizontal position based on the following equation:

$$( Equation 2 )$$

$$Device Orientation = Vertical if p > 45 degrees$$

$$Device Orientation = Horizontal if p \leq 45 degrees$$

For example, if the resultant difference between the acceleration vector V and the alpha value α, which is measured in degrees, is more than 45 degrees, the mobile device 200 may determine that its orientation is considered to be in a vertical position; and if the same resultant difference, measured in degrees, is less than or equal to 45 degrees, the mobile device 200 may determine that its orientation is considered to be in a horizontal position.

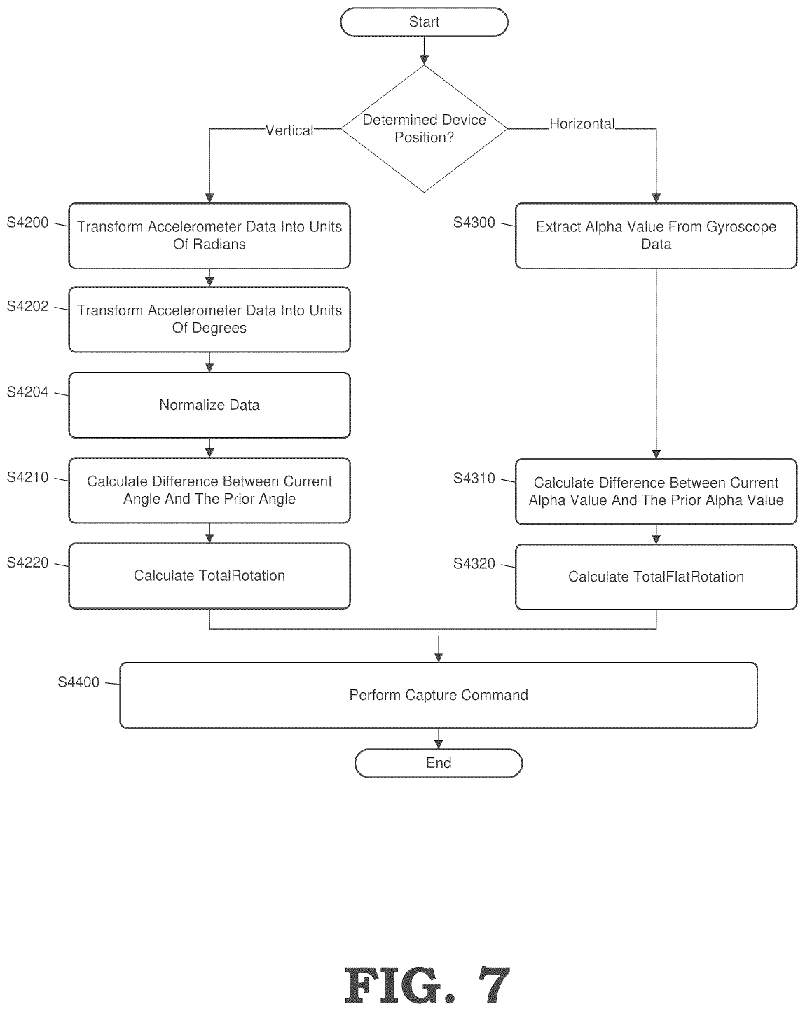

In operation S4000, the mobile device 200 may capture anatomical data on the subject anatomical data as the operator operates the mobile device based on the instructions. For example, if the mobile device 200 determines that it is in the vertical position in operation S3000, a certain set of calculations is completed to capture anatomical data. Alternatively, if the mobile device 200 determines that it is in the horizontal position, a different set of calculations is completed to capture anatomical data. The capture of anatomical data in operation S4000 is discussed in more detail below with reference to FIG. 7.

In operation S5000, the mobile device 200 may collect metadata, associate the anatomical data with the metadata, and store this metadata in the memory along with final reading. The metadata may include, for example, “DeviceInfo”, “AccelerometerData”, “GyroscopeData”, “SubjectData”, and/or “TimeData.” The DeviceInfo may include information on the mobile device 200 such as the type and version of the mobile device 200 and the version of the operating system running on the mobile device 200. The TimeData may include information indicating the time from when the operator performed the initialization operation to time of receipt of the capture command, AcceleromterData and GyroscopeData may include acceleration information and angular velocity information, respectively.

In operation S6000, the mobile device 200 display the anatomical data in real-time on the mobile device 200 such that the operator of the mobile device 200 can view updates to the ROM or postural measurements in real-time. The displayed anatomical data may include the ROM or postural measurements and may be a degree of rotation of a joint calculated based on the calculations described in detail above as part of operation S4000.

In operation S7000, the mobile device 200 may transmit the anatomical data to the server 100. In some example embodiments, the mobile device 200 may also transmit the metadata associated with the anatomical data to the server 100.

In operation S8000, the mobile device 200 may determine whether there are additional measurements to capture based on the list of measurements associated with the assessment. For example, the mobile device 200 analyze the set order and determine whether there is any additional anatomical data to capture based on the set order.

If the mobile device 200 determines that there is additional anatomical data to capture, the mobile device 200 may proceed back to operation S1000 and perform a subsequent initialization operation, after which the mobile device 200 may determine the device position, and then instruct the operator to capture the next anatomical data of the subject based on the set order. If the mobile device 200 determines that there are no additional anatomical data to capture, the mobile device 200 may proceed to the next operation.

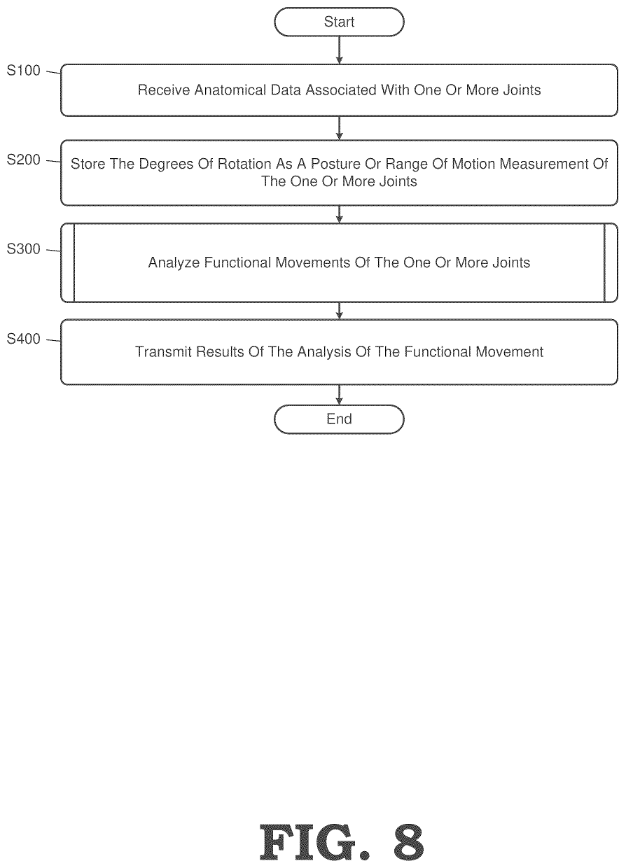

In operation S9000, the mobile device 200 may request the server 100 perform an analysis of a functional movement of the subject based on the transmitted anatomical data, and receive and display a result of the assessment to the operator of the mobile device 200. Details regarding the result of the assessment provided to the operator will be discussed below with reference to FIGS. 8-11.

FIG. 7 illustrates a method of operating a mobile device to capture anatomical data of a subject according to example embodiments.

Referring to FIGS. 6 and 7, as discussed above, in operation S4000, the mobile device may capture anatomical data on the subject by performing different calculations depending on whether the mobile device 200 is in a horizontal position or a vertical position. For example, if the mobile device 200 determines that the mobile device 200 is considered positioned in a vertical position, the mobile device 200 may proceed to perform operations S4200 to S4220. In contrast, if the mobile device 200 determines that the mobile device 200 is considered positioned in a horizontal position, the mobile device may proceed to perform operations S4300 to S4320.

In operation S4200, if the mobile device 200 determines that the mobile device 200 is considered positioned in the vertical position, the mobile device 200 may utilize the accelerometer sensor to determine the devicemotion events, accurately capturing the anatomical data. The accelerometer may determine acceleration (in m/second²) of the mobile device 200 in three axes (X, Y, Z), such that the X, Y, and Z values measure linear acceleration along each axis of the mobile device 200. Specifically, the X value measures acceleration in the left and right direction, the Y value measures acceleration in the forward and backward direction, and the Z value measures acceleration in the up and down direction. The mobile device 200 may calculate the anatomical data using Equation 2, which returns a value in radians:

$${Angle}_{in radians} = a tan 2 ( Y , X ) \qquad ( Equation 3 )$$

In operation S4202, the mobile device 200 may convert the result of Equation 2 into degrees by multiplying the result by (180/T), using the following formula:

$$Angle in degrees = Angle in radians ⋆ ( 180 / π ) \qquad ( Equation 4 )$$

In operation S4204, to normalize the angle in a range of 0-360 degrees, the mobile device 200 adds 360 and takes the modulo with respect to other angles, using the following formula:

$$Angle normalized = Angle in degrees + 360 ) mod 360 \qquad ( Equation 5 )$$

In operation S4210, the mobile device 200 may then calculate the difference between the current angle and previous angle, such that as the operator moves the mobile device 200 between the point where the initialization operation is performed and the capture operation is executed, the mobile device 200 continuously receives data from the accelerometer sensor; the current angle represents the real-time result of the normalized angle described in operation S4202 of the mobile device 200 at that precise moment, while the previous angle refers to the immediately preceding normalized angle described in operation S4202 of the device a moment before the current angle, allowing for the calculation of incremental changes in devicemotion. using the following formula:

$$Δ Angle = Current angle - Previous angle \qquad ( Equation 6 )$$

In operation S4220, the mobile device 200 may accumulation of angle differences while in the vertical position as “totalRotation” to maintain a continuous count of devicemotion in that direction, using the following formula:

$$( Equation 7 )$$

$$totalRotation = Δ {Angle}_{1} + Δ {Angle}_{2} + Δ {Angle}_{3} + … + Δ {Angle}_{n}$$

In contrast, In operation S4300, if the mobile device 200 determines that the mobile device 200 is considered positioned in the horizontal position, the gyroscope sensor may be used to determine the deviceorientation events, accurately capturing the anatomical data. The mobile device 200 may extract the alpha value (i.e., the value representing rotation around the z-axis in relation to the gyroscope) to track changes in the orientation of the mobile device 200.

In operation S4310, the mobile device 200 may then calculate the difference between the current and previous alpha values, such that as the operator moves the mobile device 200 between the point where the initialization operation is performed and the capture operation is executed, the mobile device 200 continuously receives data from the gyroscope sensor; the current alpha represents the real-time alpha value described in operation S4300 of the mobile device 200 at that precise moment, while the previous alpha refers to the immediately preceding alpha value described in operation S4300 of the mobile device 200 at a moment before the current alpha, allowing for the calculation of incremental changes in the rotation of the mobile device 200, using the following formula:

$$Δ α = Current α - Previous α \qquad ( Equation 8 )$$

In operation S4320, the mobile device 200 corrects for scenarios where the device orientation crosses the 0-degree to 360-degree boundary, ensuring accurate capture of anatomical data. The mobile device 200 accumulates the alpha differences to maintain a continuous account of deviceorientation in that direction, with this accumulation referred to as “totalFlatRotation”, using the following formula:

$$totalFlatRotation = Δ {α}_{1} + Δ {α}_{2} + Δ {α}_{3} + … + Δ {α}_{n} \qquad ( Equation 9 )$$

Thereafter, in operation S4440, The mobile device 200 may capture anatomical data measured at the time when the operator provides a “capture” command via the user interface of the mobile device 200. This capture command is performed identically in both the vertical and horizontal positions. For the scenarios in both vertical and horizontal positions, the anatomical data that is stored, as described in detail below, is called the “final reading.”

FIG. 8 illustrates a method of operating a server to analyze functional movement based on captured anatomical data according to example embodiments.

Referring to FIGS. 1-8, in operation S100, the server 100 may receive anatomical data associated with a measurement of one or more joints of a subject. Further, the server 100 may also receive the metadata associated with the captured anatomical data. For example, as discussed above, the mobile device 200 may be configured to transmit the captured anatomical data and the metadata to the server 100. The anatomical data may be measured in degrees.

In operation S200, the server 100 may store the anatomical data in a database along with database information.

The database information may include the name of the measurement, the date and time, subject demographic information, and/or operator demographic information. Some of the database information may be extracted from the metadata and other database information may be manually entered by, for example, the operator.

The database information may be stored (e.g., prestored) in a database, for example, in the memory 130, and may also contain data indicating, for each measurement, an ideal level of the ROM or posture for that measurement. Further, instead or in addition to indicating the ideal level of the ROM or postural measurements, the database information may include groupings of ranges of ROMs or postural data for each measurement where, for each measurement the groupings of ranges of ROMs or postural data is classified as being associated with respective ones of a plurality of severity categories, for example, “Ideal,” “Moderate,” or “Severe” function for that measurement. Furthermore, the database information may further include information indicating associating a joint with a plurality of measurements, which, as discussed below, may be used to score the joint.

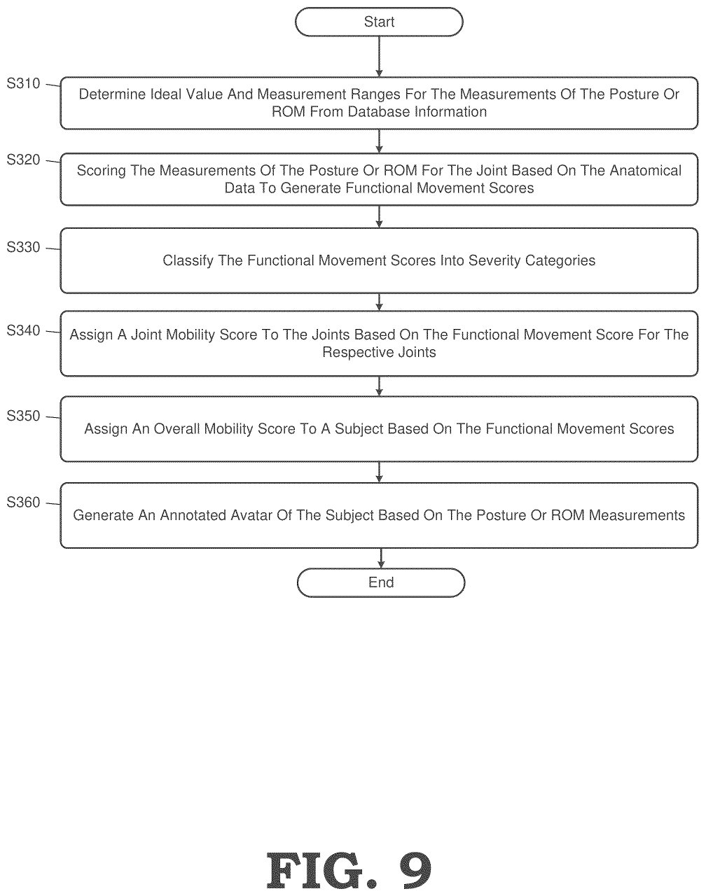

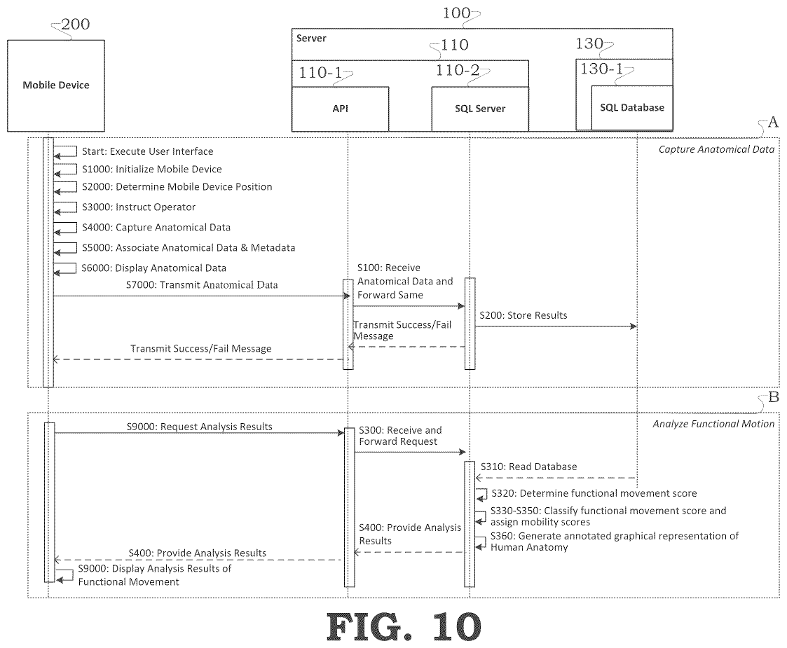

In operation S300, the server 100 may analyze functional movements of one or more joints of the user based on the collected anatomical data and the database information. Operation S300 will be discussed in more detail below with reference to FIG. 9.

In operation S400, the server 100 transmit the results of the analysis of the functional movements.

For example, in some example embodiments, the server 100 may generate data and provide such data to the mobile device 200 for display on the user interface of the mobile device 200. The mobile device 200 may receive the information in real-time depending on which tab the operator of the mobile device 200 is viewing.

The operation of the server 100 and the mobile device 200 according to example embodiments address limitations of conventional tools for capturing anatomical range of motion (ROM) and postural data. Unlike traditional methods, which often rely on analog devices or dedicated equipment that offer minimal data insights, example embodiments leverage advanced mobile device technology, incorporating gyroscopes and accelerometers, to precisely measure ROM and posture in three dimensions. The mobile device 200 not only captures this data with high accuracy but also provides real-time feedback and analysis via a server-based system. This integrated approach allows medical professionals, allied health workers, and performance specialists to efficiently capture comprehensive ROM and postural data, assess it, and generate visual feedback via a user interface. Moreover, example embodiments provide the ability to track and accumulate anatomical data, store it alongside key metadata-including device information, accelerometer, and gyroscope readings, and analyze the accumulated anatomical data in conjunction with prestored relational datasets, thus, offering a transformative way to analyze functional movement. This results in precise diagnostics and the ability to categorize ROM and postural data into levels of severity, helping operators determine the need for further evaluation or corrective interventions. This system represents a significant technical improvement, providing a scalable, efficient, and user-friendly solution for accurately assessing and improving a subject's range of motion and posture.

In some example embodiments, although not illustrated in the figures, the server 100 may assign one or more interventions to the subject based on the results of the analysis. For example, the server 100 may read a collective program of interventions associated with a particular movement disorder from memory 130, and choose particular ones of the interventions to assign to the subject based on the results of the analysis.

FIG. 9 illustrates a method of analyzing functional movement of one or more joints according to example embodiments.

Referring to FIGS. 8 and 9, as discussed above, in operation S300 the server 100 may analyze functional movements of one or more joints of the user based on collected anatomical data and database information.

For example, in operation S310, the server 100 may read, from the relational database 130-1 stored in the memory 130, information such as the anatomical data, metadata and database information, and determine an ideal value level of the ROM or posture associated with a measurement, and measurements ranges associated with respective ones of the plurality of severity categories.

As discussed above with regards to FIG. 6, the mobile device 200 may be configured to collect and transmit metadata associated with the anatomical data to the server 100, which processes both the anatomical data and the metadata for analysis purposes. The metadata may include at least TimeData, SubjectData, and OperatorData, each contributing to different aspects of the functional movement analysis. The server 100 may utilize the TimeData to analyze the subject's functional movement across multiple time periods, capturing the exact month, day, year, hour, minute, and second, enabling comparisons that identify changes or trends over time. The SubjectData provides demographic-specific insights, allowing the server 100 to relate the functional movement analysis to age, gender, or other demographic factors of the subject, tailoring the output to the subject's characteristics. OperatorData links the anatomical data to the specific operator of the mobile device 200, allowing the server 100 to analyze the accuracy and consistency of assessments performed by different operators, thus, ensuring quality control. This feedback mechanism allows for identifying potential discrepancies and ensures the validity of the data collected by the operators, further refining the system's assessments.

In operation S320, the server 100 may determine a functional movement score associated with each measurement based on the indication of the ROM and posture of the joint and the database information.

For example, the server 100 may read from the database information to determine, for each of the plurality of severity categories, the corresponding groupings of ranges associated with the measurement, and the applicable rules to determine the functional movement for that range.

The rules may be determined, for example, in advance, and stored as part of the database information, and may include a plurality of rules determined through empirical study and provide an accurate functional movement score based on the assigned severity category. The mobile device 200 may utilize different equations or rules to determine the functional movement score depending on which severity category (e.g., Ideal, Moderate, or Severe) is assigned to a given ROM or postural measurement. Each unique ROM or postural measurement has a distinct range of degrees associated with its severity categories, meaning the number of degree values that define each range is specific to that particular measurement. The equations in each rule are designed to convert the raw anatomical data, captured in degrees, into a percentage score ranging from 0% to 100%. For each range of degrees, the equations utilized output the corresponding functional movement score are formulated such that the ideal range is between, for example, 100% and 90%. Similarly, the moderate range is, for example, between 89% and 45%. For the Severe range, the equations utilized output the corresponding functional movement score of the highest value corresponds to, for example, 44%, and the lowest value is 0%. These thresholds ensure that the conversion of anatomical data to percentage scores accurately reflects the degree of functional movement across the severity spectrum, tailored to the unique ranges of each measurement.

For example, for each measurement, the server 100 may determine that:

| Measurement Ranges | Threshold | Category | Rule |
|---|---|---|---|
| W° to X-1°; | X | “Ideal” | Rule 1; |
| X° to Y-1°; and | Y | “Moderate”; and | Rule 2; and |
| Y° to Z°. | — | “Severe. | Rule 3. |

Using the Cervical Extension ROM measurement as an example, assuming that a Cervical Extension ROM measurement of 30 degrees and the database information indicates that the Cervical Extension ROM measurement is divided into three severity categories: “Ideal” assigned 0-26 degrees, “Moderate” assigned 27-53 degrees, and “Severe” assigned 54-60 degrees, the server 100 may take the captured anatomical data of 30 degrees, and select Rule 2.

Rules 1, 2 and 3 may state that, for the Cervical Extension ROM measurement, the functional movement score (FMS) is calculated using the following formulas:

FMS=(90+(((100−90)*(Anatomical Data−Y))/(Z−Y))) Rule 1:
Rule 1 converts the anatomical data into a relative percentage from 90%-100%

FMS=(45+(((90−45)*(Anatomical Data−X))/(Y−X))) Rule 2:
Rule 2 converts the anatomical data into a relative percentage from 45%-89%.

FMS=(0+(((45−0)*(Anatomical Data−W))/(X−W))) Rule 3:
Rule 2 converts the anatomical data into a relative percentage from 0%-44%.

Further, in operation S330, the server 100 may classify the functional movement score of the measurement to one of the plurality of severity categories based on the measurements and the database information, which may include the categories of “Ideal,” “Moderate,” and “Severe” functional movement.

For example, the database information read by the server 100 may include information indicating for a measurement named “Cervical Rotation,” anatomical data less than or equal to 35 degrees may be classified as “Severe,” anatomical data greater than 35 degrees and less than or equal to 71 degrees may be classified as “Moderate,” and anatomical data greater than 71 degrees and less than or equal to 80 degrees may be classified as “Ideal.”

Further still, in operation S340, the server 100 may assign a joint mobility score to the one or more joints of the subject based on the functional movement scores (fms) for multiple measurements that are associated with a same one of the joints by calculating the average of the previously calculated functional movement scores of each of the same measurements rounded to the nearest whole number.

The server 100 may determine a percentage of ideal movement for each of the measurements of the subject that are associated with the same joint (e.g., ankle, elbow, or hip joint), and may assign the joint mobility score to the joint of the subject as a percentage of the ideal movement. For example, if the database information indicates that four (4) distinct movements are related to a particular joint, the server 100 may average the functional movement scores determined in operation S320 associated with these four measurements to assign a joint mobility score for the joint. (e.g. (25%+30%+45%+25%)/4)=31.5%˜31% joint mobility score). As such, to determine the joint mobility score the server 100 may utilize the following formula:

$$Joint Mobility Score = Round ( {fms}_{1} + {fms}_{2} + {fms}_{3} + … {fms}_{n} ) / n ] \qquad ( Equation 10 )$$

Where fms is the functional movement scores and n is the total number of functional movement scores associated with an assessment.

For example, the movements of an ankle joint of a subject may include plantarflexion, dorsiflexion, inversion, and eversion movements, while the movements of the elbow joint of a subject may include flexion and extension movements, and the movements of a hip of a subject may include flexion, extension, abduction, adduction, circumduction, and hip rotation. As another example, a combination of the range of motion measurements called Cervical Rotation, Cervical Side-Bending, Cervical Flexion, and Cervical Extension, may be calculated into a joint mobility score for the anatomical joint called Cervical Spine.

Additionally, in operation S350, the server 100 may also assign a single overall mobility score to the assessment based on the plurality of functional movement scores calculated for the anatomical data collected in the assessment. However, example embodiments are not limited thereto. For example, in some example embodiments, the server 100 may average the functional movement scores determined in S320 associated with this assessment rounded to the nearest whole number to assign the overall mobility score to the assessment using the following formula:

$$Overall Mobility Score = Round ( fms 1 + fms 2 + fms 3 + … fmsn ) / n ] \qquad ( Equation 11 )$$

For example, if the database information indicates that four (4) distinct movements are related to a particular assessment, the server 100 may average the functional movement scores determined in operation S320 associated with these four measurements to assign an overall mobility score for the assessment. (e.g. ((87%+98+75%+55%+88%)/5=80.6%˜81% overall mobility score)

In operation S360, as discussed in more detail below, the server 100 may generate an annotated graphical representation of a human anatomy based on the plurality of severity categories assigned to the one or more measurements in the assessment.

To generate the annotated graphical representation, the server 100 may convert the severity categories into color codes. The represented colors may be assigned as follows: green for “Ideal,” yellow for “Moderate”, and red for “Severe.”

For example, the calf region of the human anatomy consists of two major muscles, the gastrocnemius and the soleus muscles. If in one assessment, the resultant anatomical data indicated 18 degrees for the gastrocnemius ROM measurement and 15 degrees for the soleus ROM measurement, the server 100 may determine that 18 degrees for gastrocnemius represents the “Ideal” category and therefore may assign the green color. Further, the server 100 may determine that the 15 degrees for the soleus represents the “Moderate” category and therefore may assign the yellow color. Therefore, the server 100 may annotate the graphical representation to be displayed on the user interface of the mobile device 200 to show a green color on the gastrocnemius muscle and a yellow color on the soleus muscle.

FIG. 10 illustrates data flow diagrams associated with determining the anatomical data and analyzing the functional movement according to example embodiments.

Referring to FIG. 10, in the upper flow diagram A, the anatomical data may be captured and displayed. First, the operator of the mobile device 200 may launch an application that provides a user interface to the operator. Thereafter, as discussed above, the mobile device 200 may perform the initialization operation in operation S1000 and control the user interface to instruct the user to measure a particular ROM or postural measurement in operation S2000. The particular ROM or postural measurement may be one of a plurality of ROM or postural measurements that are associated with an assessment. In operation S4000, the operator may operate the mobile device 200 to capture and display the anatomical data while moving a body part associated with the ROM or postural measurement, such as a limb of the subject. The mobile device 200 may determine a final ROM or postural measurement, such as a final reading, and may cease capturing the particular ROM or postural measurement. The mobile device 200 may utilize devicemotion and deviceorientation operations to transform the collected values into degrees of rotation, which may be easily understandable by the operator.

In operation S5000, the mobile device 200 may associate the captured anatomical data, which includes the final ROM or postural measurement, such as the final reading, with relevant metadata such as the name of the measurement, and the date and time of the measurement. In operation S6000, the mobile device 200 may display the captured anatomical data to the operator in real-time. In operation S7000, the mobile device 200 may transmit the captured anatomical data to the server 100. The mobile device 200 may also transmit the relevant metadata to the server 100. To communicate the anatomical data and metadata, the application running on the mobile device 200 may communicate with the Application Program Interface (API) 110-1 running on the processing circuitry 110 of the server 100.

After receiving the anatomical data and metadata, in operation S100, the API 110-1 may forward the same to the database server 110-2. In operation S200, the database server 110-2 may store the information in the memory 130, such as in the relational database 130-1, which may be a SQL database. A transmit success/failure message may be propagated upstream back to the mobile device 200.

In the lower flow diagram B, the functional movement may be analyzed based on the captured data. In operation S9000, the mobile device 200 may request the analysis results (which may consist of the functional movements scores of the plurality of measurements, joint mobility scores of the plurality of joints, the overall mobility score for the assessment, and the annotated graphical representation of the human anatomy) from the server 100 and subsequently receive the analysis results from the server 100 by communicating with the Application Program Interface (API) 110-1 running on the processing circuitry 110 of the server 100.

After receiving the request, as part of operation S300, the API 110-1 may forward the same to the SQL server 110-2. In operation S310, the SQL server 110-2 may obtain data from the SQL database 130-1. For example, the information may include the anatomical data and metadata received from the mobile device 200. The information may further include information indicating the classifications such as the severity categories for the ROM or posture measurements. As discussed above, in operations S320 to S350, the server 100 (e.g., the SQL server 110-2) may determine (S320) functional movement scores, classify (S340) the functional movement scores into severity categories, and assign (S340 and S350) joint mobility scores and overall mobility scores. Further, as discussed above, in operation S360, the server 100 (e.g., the SQL server 110-2) may generate an annotated graphical representation of a human anatomy based on the mobility scores.

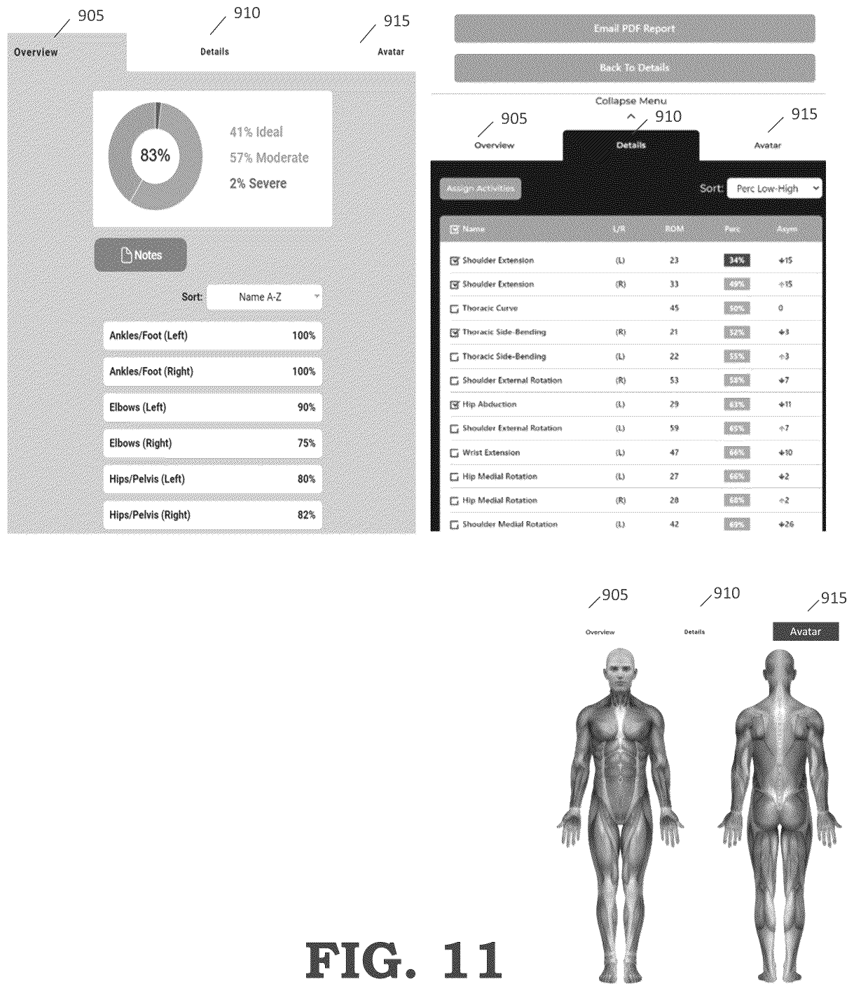

Thereafter, in operation S400, the server 100 may provide the results of the analysis to the mobile device 200, and the mobile device S9000 may receive and display the results of the analysis to the operator. The displayed results of the analysis are discussed in more detail below with reference to FIG. 11.

The operation of the server 100 and the device 200 according to example embodiments address limitations of conventional tools for capturing anatomical range of motion (ROM) and postural data. Unlike traditional methods, which often rely on analog devices or dedicated equipment that offer minimal data insights, example embodiments leverage advanced mobile device technology, incorporating gyroscopes and accelerometers, to precisely measure ROM and posture in three dimensions. The mobile device 200 not only captures this data with high accuracy but also provides real-time feedback and analysis via a server-based system. This integrated approach allows medical professionals, allied health workers, and performance specialists to efficiently capture comprehensive ROM and postural data, assess it, and generate visual feedback via a user interface. Moreover, example embodiments provide the ability to track and accumulate anatomical data, store it alongside key metadata—including device information, accelerometer, and gyroscope readings, and analyze the accumulated anatomical data in conjunction with prestored relational datasets, thus, offering a transformative way to analyze functional movement. This results in precise diagnostics and the ability to categorize ROM and postural data into levels of severity, helping operators determine the need for further evaluation or corrective interventions. This system represents a significant technical improvement, providing a scalable, efficient, and user-friendly solution for accurately assessing and improving a subject's range of motion and posture.

FIG. 11 illustrates a user interface according to example embodiments.

Referring to FIG. 11, the server 100 may generate a user interface that provides various information to the operator that provides an analysis of the functional movement of the subject. The server 100 may generate the user interface that provides various information to the operator as the operator operates the user interface via the mobile device 200.

For example, the information may be categories between various tabs including an overview tab 905, a details tab 910 and an avatar tab 915.

For example, from the overview tab 905, the operator may control the server 100 to calculate and transmit information to the mobile device 200 that provides an overview of the mobility of the subject. For example, the server 100 may assign the joint mobility score to the one or more joints of the subject based on the ROM or postural measurements that are associated with respective joints and information stored in a database indicating an ideal movement for a respective ROM or postural measurements. Further, the server 100 may also assign a single overall mobility score to the subject based on the postural and ROM scores for each of the joints of the subject, and may classify the overall mobility score in one of a plurality of severity categories, for example, ideal movement, moderate movement, or severe movement. However, example embodiments are not limited thereto. When the operator is in the overview tab 905, the mobile device 200 may receive the joint mobility scores and overall mobility score assigned in operations S340 and S350, respectively, and may display the results of analyzing the functional movement to the operator in a high level form.

For example, the ROM measurements of an ankle joint of a subject may include ROM measurements for plantarflexion, dorsiflexion, inversion, and eversion movements, while the ROM measurements of the elbow joint of a subject may include ROM measurements for flexion and extension movements, and the ROM measurements of a hip of a subject may include ROM measurements for flexion, extension, abduction, adduction, circumduction, and hip rotation. The server 100 may determine a percentage of ideal movement for each of the known movements of the subject, and may assign the joint mobility score to the joint of the subject as a percentage of on the ideal movement.

When an operator uses the user interface to switch to the details tab 910, the server 100 may calculate and transmit more detailed information to the operator regarding the mobility of the subject.

The mobile device 200 may receive information indicating the functional movement score associated with the ROM or postural measurements and severity category classification determined in operations S320 and S330, respectively. Based on such information the mobile device 200 may compile the details 910 tab that indicates the same.

In addition to displaying numerical data to the operator, the server 100 may also generate a graphical depiction of the results of analyzing the functional movement to the operator, for example, in the form of an avatar.

For example, when an operator uses the user interface to switch to the avatar tab 915, the server 100 may generate a graphical representation of a human anatomy and annotate the graphical representation of the human anatomy to indicate the severity categories associated to corresponding areas of the body of the subject. In some example embodiments, the server 100 may generate a different graphical representation of the human anatomy based on the sex of the subject. In some example embodiments, the annotation may be color coding the graphical representation of the human anatomy in green for ideal, yellow for moderate and red for severe. However, example embodiments are not limited thereto. The server 100 may transmit the annotated graphical representation of the human anatomy to the mobile device 200 for display to the operator on the user interface.

For example, the server 100 may color the respective muscle fibers responsible for moving the anatomical joint called Cervical Spine red if classified Severe, yellow-orange if classified Moderate, and green if classified Ideal.

Example embodiments allow a subscribing operator to easily and quickly assess every joint and body region of a subject without specialized equipment through the use of a mobile device 200 operating software that interacts with and controls existing functions of the mobile device 200 to generate data that can be utilized to accurately capture anatomical data representing the posture or ROM of joint of a subject, and allow an operator to immediately store, view the data in real time. Some example embodiments may deliver customized interventions to their subjects individually or in groups, and may refer a qualifying subject for further evaluations from an operator. Some example embodiments also allow the subjects to access the platform to view the results of their functional movement analysis, and the customized interventions assigned by the operator.

This written description uses examples of the subject matter disclosed to enable any person skilled in the art to practice the same, including making and using any devices, systems, and/or non-transitory computer readable media, and/or performing any incorporated methods. The patentable scope of the subject matter is defined by the claims, and may include other examples that occur to those skilled in the art. Such other examples are intended to be within the scope of the claims.

What is claimed is:

1. A mobile device, comprising:
processing circuitry and a memory, the memory containing computer readable code that, when executed by the processing circuitry, configures the mobile device to capture anatomical data for a subject and perform an assessment of a functional movement of the subject based on the anatomical data for the subject by,
capturing the anatomical data for the subject via the mobile device such that the anatomical data includes range of motion (ROM) or postural measurements of one or more joints of the subject determined based on a rotation of the mobile device along a z-axis collected by one or more of an accelerometer and a gyroscope embedded within the mobile device,
instructing a server to analyze the functional movement of the subject based on the anatomical data and to generate assessment data based on same, and
displaying, via a user interface of the mobile device, the anatomical data and the assessment of the functional movement of the subject based on the assessment data received from the server.

2. The mobile device of claim 1, wherein the mobile device is further configured to perform an initialization operation to set an initial rotational angle based on an angle the mobile device is positioned on the subject when an initialization command is received from an operator, and to determine the rotation of the mobile device along the z-axis based on the initial rotational angle.

3. The mobile device of claim 1, wherein the mobile device is further configured to determine whether the mobile device is positioned horizontally or vertically based on a difference between an acceleration vector which includes components sensed by the accelerometer and an output of the z-axis which is a component sensed by the gyroscope.

4. The mobile device of claim 3, wherein the mobile device is configured to capture the anatomical data for the subject by,
calculating a degrees of rotation of the mobile device in a vertical plane based on accelerometer data associated with the accelerometer embedded within the mobile device, in response to the anatomical data being captured while the mobile device is determined as being positioned vertically; and
calculating the degrees of rotation in a horizontal plane based on gyroscope data associated with the gyroscope embedded within the mobile device, in response to the anatomical data being captured while the mobile device is determined as being positioned horizontally.

5. The mobile device of claim 1, wherein the mobile device is configured to display the assessment of the functional movement by displaying one or more of functional movement scores, a joint mobility score, severity categories, an overall mobility score, and an avatar of the subject.

6. The mobile device of claim 1, wherein
the mobile device is further configured to collect metadata associated with the anatomical data and transmit the metadata to the server, the metadata including at least time data, subject data, and operator data, and
wherein the server is configured to analyze the functional movement based on the anatomical data and the metadata by,
obtaining demographic-specific insights applicable to the subject based on the subject data,
analyzing the functional movement of the subject across different time periods, which are identified based on the time data, and
linking the anatomical data to a specific operator of the mobile device based on the operator data such that the server is configured to generate quality control data indicating an accuracy of the assessment conducted by different operators.

7. The mobile device of claim 1, wherein the mobile device is further configured to instruct an operator thereof to capture the anatomical data associated with different ones of the ROM or postural measurements.

8. The mobile device of claim 7, wherein the mobile device is configured to instruct the operator thereof to capture the anatomical data associated with each of the ROM or postural measurements in a set order, the set order being customizable and reusable by the operator when evaluating different ones of a plurality of subjects.

9. The mobile device of claim 7, wherein the mobile device is configured to allow the operator to skip or redo the capturing of the anatomical data associated with one or more the ROM or postural measurements in response to input from the operator.

10. A method of operating a mobile device to capture anatomical data for a subject and perform an assessment of a functional movement of the subject based on the anatomical data for the subject, the method comprising:
capturing the anatomical data for the subject via the mobile device such that the anatomical data includes range of motion (ROM) or postural measurements of one or more joints of the subject determined based on a rotation of the mobile device along a z-axis collected by one or more of an accelerometer and a gyroscope embedded within the mobile device;
instructing a server to analyze the functional movement of the subject based on the anatomical data and to generate assessment data based on same; and
displaying, via a user interface of the mobile device, the anatomical data and the assessment of the functional movement of the subject based on the assessment data received from the server.

11. A server, comprising:
processing circuitry and a memory, the memory containing computer readable code that, when executed by the processing circuitry, configures the server to analyze functional movement of a subject based on anatomical data for the subject by,
receiving the anatomical data for the subject captured by a mobile device, the anatomical data including range of motion (ROM) or postural measurements of one or more joints of the subject determined based on a rotation of the mobile device along a z-axis collected by one or more of an accelerometer and a gyroscope embedded within the mobile device,
storing the anatomical data in a database within a memory device,
analyzing the functional movement of the one or more joints of the subject based on the ROM or postural measurements and database information, and
transmitting results of the analyzing of the functional movement of the one or more joints of the subject to the mobile device.

12. The server of claim 11, wherein the server is configured to,
receive metadata associated with the anatomical data for the subject from the mobile device such that the metadata includes at least time data, subject data, and operator data, and
analyze the functional movement based on the anatomical data and the metadata by,
obtaining demographic-specific insights applicable to the subject based on the subject data,
analyzing the functional movement of the subject across different time periods, which are identified based on the time data, and
linking the anatomical data to a specific operator of the mobile device based on the operator data such that the server is configured to generate quality control data indicating an accuracy of the assessment conducted by different operators.

13. The server of claim 11, wherein the server is configured to analyze the functional movement by,
determining, from the database information stored in the database, ideal values for respective ones the ROM or postural measurements and a plurality of measurement ranges associated with each of the ROM or postural measurements;
scoring the ROM or postural measurements based on respective ones of the ideal values to generate functional movement scores;
classifying the functional movement scores into respective ones of a plurality of severity categories based on which of the plurality of measurement ranges that the ROM or postural measurements falls within; and
assigning a joint mobility score to the one or more joints based on the functional movement scores assigned to the anatomical data associated with a respective one of the one or more joints.

14. The server of claim 13, wherein the server is further configured to analyze the functional movement by,
assigning an overall mobility score to the subject based on the functional movement scores assigned to all of the one or more anatomical data associated with an assessment of the subject.

15. The server of claim 14, wherein the server is further configured to analyze the functional movement by,
generating an avatar of the subject such that the avatar indicates the severity categories assigned to corresponding ones of the ROM or postural measurements of the subject.

16. The server of claim 15, wherein the server is configured to generate the avatar by color coding a graphical representation of a human anatomy based on the ROM or postural measurements of the subject.

17. The server of claim 15, wherein the server is configured to transmit the results of the analyzing of the functional movement to the mobile device by,
transmitting one or more of the functional movement scores, the joint mobility score, the severity categories, the overall mobility score and the avatar to the mobile device for display to an operator.

18. The server of claim 17, wherein the server is configured to transmit the results of the analyzing of the functional movement in real-time as feedback to the operator as the anatomical data captured by the mobile device is received.

19. A method of operating a server to analyze functional movement of a subject based on anatomical data for the subject, the method comprising:
receiving the anatomical data for the subject captured by a mobile device, the anatomical data including range of motion (ROM) or postural measurements for one or more joints of the subject determined based on a rotation of the mobile device along a z-axis collected by one or more of an accelerometer and a gyroscope embedded within the mobile device;
storing the anatomical data in a database within a memory device;
analyzing the functional movement of the one or more joints of the subject based on the ROM or postural measurements and database information; and
transmitting results of the analyzing of the functional movement of the one or more joints of the subject to the mobile device.

20. The method of claim 19, wherein the analyzing the functional movement comprises:
determining, from the database information stored in the database, ideal values for respective ones the ROM or postural measurements and a plurality of measurement ranges associated with each of the ROM or postural measurements;
scoring the ROM or postural measurements based on respective ones of the ideal values to generate functional movement scores;
classifying the functional movement scores into respective ones of a plurality of severity categories based on which of the plurality of measurement ranges that the ROM or postural measurements falls within; and
assigning a joint mobility score to the one or more joints based on the functional movement scores assigned to the anatomical data associated with a respective one of the one or more joints.
